(19) United States
(12) Patent Application Publication
(10) Pub. No.: US 2011/0041733 A1
(43) Pub. Date: Feb. 24, 2011

(54) METHOD FOR PRODUCING AN AGGREGATE FOR PRODUCING BUILDING MATERIALS

(76) Inventors: Andreas Bartl, Wien (AT); Michael Wistuba, Wien (AT); Ingo Marini, Rudersdorf (AT); Markus Spiegl, Wien (AT); Ronald Blab, Langezersdorf (AT)

Correspondence Address: GREER, BURNS & CRAIN, 300 S WACKER DR, 25TH FLOOR, CHICAGO, IL, 60606, US

(21) Appl. No.: 12/599,873

(22) PCT Filed: May 21, 2008
(86) PCT No.: PCT/EP08/56255

§ 371 Date: Oct. 25, 2010

(30) Foreign Application Priority Data
May 21, 2007 (AT) A 791/2007

(51) Int. Cl. C04B 24/36; C04B 14/00

(52) U.S. Cl. 106/668; 106/400

(57) ABSTRACT

The invention relates to a method for producing an aggregate for the production of building materials, wherein a starting material containing at least one fibre-containing waste fraction has had heavy materials removed and been comminuted in order to obtain a substantially free-flowing aggregate. Improved product properties can be achieved in such a way that the fibre content is set between 3% and 45%, preferably between 5% and 25%, and more preferably between 7% and 12%, and a mass fraction of between 2% and 25%, preferably between 2% and 10%, and more preferably between 3% and 8%, of a fine-grain inorganic additive is set. The invention further relates to an aggregate produced according to this method, and to asphalt or concrete.

### BACKGROUND OF THE INVENTION

The invention relates to a method for producing an aggregate for the production of building materials, wherein a starting material containing at least one fiber-containing waste fraction has had heavy materials removed and has been comminuted in order to obtain a substantially free-flowing aggregate.

Methods have recently been developed worldwide, and especially within the EU, which are aimed at avoiding and/or reducing waste. This is occurring not only as a result of an increased awareness for environmental matters within the population, but also by respective legislative frameworks.

There are more or less closed-loop systems, with the product per se, the material or the raw material being recycled. For more complex materials such as composite materials and especially consumer products such as household or kitchen appliances, motor vehicles or electronic devices, hardly any such closed-loop systems have been realized yet.

One possibility to at least partly use waste that is composed in a complex way is the comminution of the waste in shredder systems. Bulky waste is shredded, ranging from scrap cars, stoves, washing machines, dishwashers up to light mixed scrap material such as bicycles and bed frames. After the comminution, the magnetizable parts (iron fraction) and the non-magnetizable parts (non-iron fraction: aluminium, copper) are separated for recycling. These methods have long been the state of the art (H. Motek, “Aufbereitungs-Technik” (Processing Technology) 16(8), 387-392, 1975).

The disadvantage in processing waste in shredder installations is that shredder waste, i.e. the so-called light shredded fraction, is obtained in addition to the metal fractions, i.e. the so-called heavy shredded fraction, with the light fraction having to be dumped in landfills or incinerated, primarily as a result of statutory regulations. As is known from literature, the content of this shredder waste is approx. 25% (T. Geiger, H. Baumgartner, H. Seifert, I. Dorn, H. Knopf, Chem.-Ing.-Techn. 65(4), 444-446, 1993).

Scrap cars represent a special case. The Directive 2000/53/EC of the European Parliament and the Council of 18 Sep. 2000 governs the recycling of scrap cars within the EU. Mandatory recycling quotas are determined in this Directive. Notice must be taken that only a small percentage of the scrap cars must be utilized thermally. The predominant part must be re-used or recycled. There are similar regulations for other products. At least 4 kg of electronic scrap must be recycled per inhabitant and year according to Directive 2002/96/EC (WEEE Directive).

The achievement of these quotas represents a serious challenge. As a result of increasing use of light-weight components in car construction, the percentage of steel decreases continually, whereas simultaneously the use of plastic materials and composite materials increases. The exclusive exploitation of iron and steel and non-ferrous metals from the recycling of scrap motor vehicles is unable to achieve the quotas as demanded by the Directive 2000/53/EC. It is therefore mandatory to develop new possibilities for recycling that are currently not yet available.

### BACKGROUND ART

In accordance with the state of the art, shredder waste is utilized or disposed of thermally if landfilling is no longer possible for legal reasons (prohibition of landfilling). Classic methods for thermal waste treatment include pyrolysis, gasification and incineration. The specifications CH 685377 A, DE 20 52 578 A, DE 24 36 549 A, EP 0 588 814 A, U.S. Pat. No. 3,917,239 A, U.S. Pat. No. 4,014,681 A, WO 98/054399 A for example describe the state of the art of utilizing shredder waste by means of thermal processes. Moreover, there is the TwinRec method (e.g. EP 0 676 464 A, EP 0 803 562 A), the RESHMENT method (e.g. EP 0 940 166, EP 1 064 982) and the Thermoselect method (e.g. DE 41 30 416 A) which can be regarded as special thermal processes. These methods are technically very complex and are unable to achieve any sufficiently high utilization, as demanded for example in the Directive 2000/53/EC.

In addition to the described thermal processes there are also mechanical processes according to the state of the art in order to recycle scrap cars, scrap electronic devices, and brown and white products.

A number of specifications mention processes which describe the disassembly of scrap cars before the shredding for the purpose of obtaining reusable parts such as DE 197 24 211 A, DE 36 40 501 A, DE 39 40 959 A, DE 40 19 312 A, DE 40 29 618 A, DE 41 43 251 A or DE 42 12 299 A for example. None of these processes has reached any commercial relevance. In actual fact, only relatively few components are removed for economical reasons from scrap cars or other waste materials (scrap electronic devices) before shredding.

Generally, only the components necessary for environmental reasons are removed from scrap motor vehicles (e.g. fuel, oils, lead batteries). The car bodies are then shredded jointly with the scrap electronic devices and brown and white products or similar waste. Reusable fractions can be obtained with a relatively low amount of energy input by mechanical separation methods (sifting) or other separation methods. For some time this technology has corresponded to the state of the art (A. Melin, Erzmetall 25/2 (Metallic Ores), 1972, 290-295; DE 32 35 163 A, DE 19 18 123 A, DE 15 07 557 A, EP 0 403 695 A).

DE 195 11 278 A, EP 863 114 A and DE 4439656 A further show methods which comprise the use of shredder waste for producing building materials.

Shredders are generally comminution devices which work like a hammer crusher. They are especially suitable for comminuting secondary raw materials. Usually, one distinguishes between shredders with horizontally arranged rotors on the one hand and vertically arranged ones on the other hand. Shredders with a horizontally mounted rotor usually have a grating which is classically arranged beneath the rotor. The configuration of such shredders is derived directly from a hammer crusher and has been the state of the art for many decades. A further development is the unit frequently known as “Lindemann-Newell shredder” in which the grating is arranged above the rotor. There are special configurations which primarily relate to the arrangement of the grating such as the “Becker”. Shredders with vertically mounted rotors usually have no discharge grating (e.g. Herschel mill) and are primarily suitable for pre-comminuted materials and low throughput.

Shredders are used in practice among other things for processing the following materials:

Cars

Light steel scrap (e.g. household appliances, bicycles and bed frames)

Aluminium scrap

Electric and electronic devices

Household trash (e.g. furniture from households and gardens, bathtubs, floor covers, carpets)

The material comminuted by means of the shredder generally has a grain size of less than 150 mm, offers good preconditions for separation and has good conveying properties.

Although shredder waste contains a relative high percentage of plastic materials, methods for processing plastic materials are economically not competitive. Since scrap motor vehicles are recycled jointly with other waste such as electronic devices or brown and white products, shredder waste contains a large number of different plastic materials. Shredder waste from scrap electronic devices contains up to 12 different types of plastic material. They can still contain flame retardants, with a large number of different flame retardants currently being in use. In the case of shredder waste from different sources, the composition becomes even more complex because fiber-reinforced plastic materials are especially used in car construction. Despite complex and thus expensive separation of the plastic materials, only low-quality secondary raw materials are obtained. The proceeds that can be generated with these recycled waste materials are thus very low and generally do not justify complex processing.

In addition to current methods which are suitable for various types of waste, methods were also developed in the past year which are aimed particularly at processing scrap motor vehicles, scrap electronic devices, brown and white products or similar waste materials. The following methods need to be mentioned specifically:
SRTL method (e.g. EP 0 918 606 A, U.S. Pat. No. 6,460,788 A, WO 2004/004997 A)
SiCon method (e.g. DE 100 53 487 A, DE 100 53 488 A, DE 100 53 491 A, DE 100 53 492 A, EP 0 912 310 A)
SALYP method (e.g. WO 03/090941 A, WO 2004/041452 A, EP 1 090 727 A, BE 1 014 797 A)
WESA SLF method (e.g. H. P. Sattler, B. Laage, In: R′2000: Recovery, Recycling, Re-Integration; Proc. of the 5th World Congress on Integrated Resources Management, Toronto, Canada, Jun. 5-9, 2000; E. Pruckner, Congress “Car Recycling in Europe—Chances and Risks”, Rüsselsheim, Germany, May 3-4, 2000).

In addition to the methods as described above, there are numerous further specifications which describe the state of the art in processing shredder waste. It is possible by means of all these methods to gain further valuable materials, especially iron and non-ferrous metals, from the shredder waste. No information is usually provided on the use of the other fractions, or these parts are used for thermal utilization or disposal. A fulfilment of the recycling quotas as demanded by Directive 2000/53/EC is thus not possible.

It is further known that in the course of the recycling of waste tires a lint fraction is obtained for which a number of applications are available in the field of building materials by respective process (AT 413 355 B). In comparison with incineration for which a disposal fee needs to be paid it is thus possible to generate proceeds from a material that was originally defined as waste. Especially building materials on the basis of bitumen are considered as field of application for the waste processed according to AT 413 355 B. Expensive new raw materials can be substituted by using the lint fraction from waste tire recycling. The disadvantageous aspect in this method is on the one hand that it is exclusively suitable for elastomeric products. On the other hand, the processed fraction mainly consists of fibers and can thus only substitute a portion of possible aggregates for building materials on the basis of concrete or bitumen.

### SUMMARY OF THE INVENTION

It is the object of the present invention to avoid the above disadvantages and to provide a method which allows recycling of waste materials and simultaneously provide a high-quality aggregate for the production of building materials as a product.

It is provided in accordance with the invention that a light shredded fraction is used as a starting material and the fiber content is set between 3% and 45%, preferably between 5% and 25%, and more preferably between 7% and 12%, and a mass fraction of between 2% and 25%, preferably between 2% and 10%, and more preferably between 3% and 8% of a fine-grain inorganic additive with a grain size of less than 750 μm is set.

As already mentioned above, the so-called light shredded fraction can be separated after the process of shredding. It is usually drawn off via a sifter. It is also possible to use zigzag sifters, screening machines, separating tables or other units for separation. Mainly iron scrap and other metals mostly remain in the cleaned heavy fraction. The light shredded fraction is a heterogeneous mixture of plastic and elastomers, but also contains other organic and inorganic materials. The heating value is 14 MJ/kg on average, with large fluctuations being possible as a result of the inhomogeneity of the light shredded fraction. The percentage of fine grain (<10 mm) is approx. 50%. In this case too, the value can fluctuate strongly. The material composition and the chemico-physical and mechanical properties depend highly on the composition of the raw materials and the machine parameters and vary strongly within extremely large bandwidths.

The term “fiber” is not precisely defined in technical literature. A definition (DIN 60001) prepared from the viewpoint of the most important consumer of fibers, which is the textile industry, designates fibers as elongated particles that can be processed in a textile manner. A precise definition of length diameter and ratio of length to diameter cannot be found. Fibers are usually spun into textiles in the length range of 20 to 90 mm. Fibers of lower lengths can be processed into non-woven materials. Fibrous particles are also used in the paper and pulp industry, even though the geometrical dimensions of the fibers are clearly beneath these lengths.

A more comprehensive definition is provided by BISFA (Bureau International pour la Standardisation des Fibers Artificielles) which defines fibers as a morphological name for such materials which are characterized by their flexibility, fineness and large ratio of length to cross-sectional area (BISFA; Terminology of man-made fibers, 2000). Fibers are thus clearly delimited from rods (no sufficient flexibility) and wires (no sufficient fineness). BISFA also does not provide any clearly defined dimensions or limits. Moreover, BISFA defines further terms:
Fibril: Defines a structuring of a fiber; it can attach to the fiber or be loose.
Fiber dust: Fibers or parts of fibers that are present as suspended matter in air; they can be recognized by the human eye as fibers.
Flock: Very short fibers which are intentionally produced for purposes other than for spinning.
Staple fiber: Textile fibers of finite length that can be spun.
Filament: Fibers of a very large length that can be regarded as infinite.

Fixed limit values for fiber geometries exist only in the field of respirable fibers which are rated as being hazardous to health. In accordance with various guidelines (e.g. TRGS 521), such fibers are regarded as respirable which fulfil all of the three following criteria:

The fiber length lies over 5 μm.

The fiber diameter lies under 3 μm.

The ratio of fiber length to fiber diameter lies over 3.

Since there are no mandatory or standardized regulations concerning the designation “fiber”, fiber shall be designated within the terms of the aggregate in accordance with the invention as a particle which has a ratio of length to diameter of 10 or above. In the case of fibers with a round or approximately round cross section, the diameter of the fiber can be used directly. In the case of fiber cross sections which deviate considerably from a circular shape it is necessary to calculate the diameter of the circle which has the same surface as the cross-sectional area of the fiber. Only such particles are designated as fibers which in addition to the ratio of length to diameter of 10 or above also have a diameter in the range of 5 to 80 μm. In the case of cross sections which are not round, the diameter of the circle corresponding to the fiber cross section with the same surface area shall be used. Fibers with diameters less than 5 μm must be avoided because these fibers do not show any positive effect on the quality of the end products produced in accordance with the invention.

In addition to the difficulty of the definition of fibers, the morphological analysis of fibers also causes serious problems. It is undisputed that systems with particles and/or fibers represent a disperse system which consists of an uncountable quantity of single individual particles. It is therefore common practice in the field of mechanical process engineering to describe such systems, in addition to the chemical composition, by the shape and size of the particles. Since the individual particles are usually shaped in an irregular fashion, it is common practice to calculate statistical quantities such as Feret or Martin diameter.

The use of a statistically determined mean particle diameter is not useful for describing fibers. Usually, fibers are regarded as regularly shaped particles which correspond to a cylinder. Diameter and height of the cylinder are therefore sufficient for an adequate description. For this purpose, a separate statistical mean value can be stated for each of the two parameters of fiber length and fiber diameter and optionally a probability density function or also a distribution sum.

The fact that it is not practical to provide a mean diameter also makes meaningful characterization more difficult. Most analytical methods are designed for more or less spherical particles and large deviations from the round shape lead to unusable results. This applies for example to a screen analysis which can be performed according to the state of the art by means of vibrating screens or also by means of air-jet screens. Relatively long fibers cannot be screened because the fibers form interlocking agglomerates. Individual fibers of these agglomerates can then obviously not fall through the meshes of the screen, even if this would be possible geometrically (which means that the mesh width is larger than the fiber diameter). Short fibers have a lower tendency towards agglomeration and can thus pass a screen when the fiber diameter lies beneath the mesh width of the screen. A fiber is only then able to pass the screen when the fiber axis is aligned more or less normally to the screen surface. The probability of a fiber alignment normally to the screen surface by means of vibration (vibration screen) or air movement (air-jet screen) is the higher the shorter the fiber. The fiber length thus merely influences the necessary screen duration. Laser diffraction also represents a characterization method which corresponds to the state of the art. In this case, a mean diameter is obtained, but no information on the respective fiber lengths and fiber diameters.

For this reason there is a precise determination of the fiber geometry by means of microscopic methods, in which a certain number of fibers is measured. The “Berufsgenossenschaftliche Zentrale für Sicherheit and Gesundheit (BGZ)” (Headquarters of the Professional Association for Safety and Health) provides a method for determining respirable fibers (BGI 505-31 of April 2004) in which fibers are counted under the light microscope. Such methods are very precise and can also be used for arbitral analysis. The disadvantageous aspect is a considerable amount of work despite a relatively low number of evaluated fibers (100 pieces).

Devices have recently been developed in the field of the paper and pulp industry which are designed especially for short fibers and, in addition to other parameters, can also determine the fiber length and the fiber diameter as well as the respective probability density function. A device is on the market under the name of Morfi which was developed by TECHPAP and CENTRE TECHNIQUE DU PAPIER (C.T.P.). The fibrous sample suspended in hydrous solution is pumped through a measuring cell in which photos are taken by a digital camera. A software system evaluates these pictures and can determine fiber lengths of up to 10 mm. It was determined that the fibers contained in the aggregate in accordance with the invention can be characterized very well with this Morfi analytical system. The sample preparation and measurement occur rapidly and simply and a very high number of fibers can be measured in a very short period of time (approx. 100,000 pieces in 20 minutes). As a result of the very large number of individual fibers, this analytical system is characterized by a high statistical certainty.

The relevant aspect in connection with the invention is that the aggregate is pourable, i.e. the fibers do not become felted or form cotton-wool-like structures because this would seriously impair further use.

It was surprisingly noticed that by setting the fiber content and by providing an inorganic additive it is possible to obtain a high-quality product. The fiber content leads to a mechanical improvement of the finally produced building materials, with a range of between 3% and 45% having to be maintained here. These rates concern percent by mass. An especially high strength in a wide temperature range is achieved in combination with the additive.

It is possible by the method in accordance with the invention that a large number of waste materials, especially shredder waste obtained by shredding of waste such as scrap motor vehicles, scrap electronic devices as well as brown and white goods, can advantageously be used as an aggregate for bitumen-bonded or cement-bonded building materials after processing in accordance with the invention. This provides a substantially larger spectrum of possible starting materials than was previously possible. It is a further advantage that the aggregate produced in accordance with the invention can simultaneously substitute several additives corresponding to the state of the art. As a result of the processing of a suitable waste in accordance with the invention or by mixing various types of waste, an aggregate can be produced which contains fibers, fillers, thermoplastic and elastomeric materials. It is possible in accordance with the invention to bring the individual components to the desired grain size or desired fiber length by mechanical process steps.

This method now remedies the disadvantages of known methods with which waste materials were processed up until now. It is not necessary to achieve a laborious, but mostly incomplete separation of the individual waste components.

The processing in accordance with the invention exclusively uses mechanical methods such as cutting and grinding, air classification or granulation in which no significant solid, fluid or gaseous waste is produced.

In accordance with the invention, various waste materials can be used such as especially shredder waste of scrap motor vehicles, scrap electronic devices as well as brown and white goods. It is advantageous to pre-separate the shredder waste according to the start of the art. Components that can be easily recycled such as metals or plastic granulates can be separated and sold profitably. It is especially advantageous to use a lint fraction as starting material. It is optionally necessary to use various waste materials in order to achieve the required concentrations of the active components. Optionally, it is also possible to admix individual components both as new material and also as recycled material to the aggregate in order to achieve the composition in accordance with the invention.

The aggregate is obtained in accordance with the invention by the following steps. The sequence of processing can be varied according to the type of the fraction to be prepared or according to the desired subsequent application. Individual steps can optionally also be omitted or also be repeated. All process steps are performed in dry process.
Mechanical comminution of the waste; the comminution can advantageously occur by means of a cutting mill and/or an impact mill.
Screening of the shredder waste; conventional vibration screens, ultrasonic screens or air-jet screens can advantageously be used.
Sifting/classifying the shredder waste; zigzag sifters or deflecting wheel sifters can be used.
Granulation of the processed fractions.

The setting of the required values for the fiber content and the inorganic additive occurs either via a respective pre-sorting or the choice of the starting material, by mixture of different fractions of starting material, by setting the separation processes during the separation of the light fraction or by purposeful addition of additional components such as rock flour or the like.

The aggregate produced by the method in accordance with the invention can be used in the production of concrete or asphalt.

Concrete is a mixture of cement (hydraulic bonding agent), aggregate (sand or gravel or grit) and water produced in the cold state. It can also contain concrete admixtures and concrete additives.

The cement is used as a bonding agent in order to hold the other components together. The strength of the concrete is obtained by the crystallization of the clinker components of the cement, through which minute crystal needles are formed which mesh tightly. The crystal growth continues over months, so that the final strength is achieved only long after the casting of the concrete. Standard strength under normal temperature and humidity conditions is achieved after 28 days, as assumed in DIN 1164 (strength classes of cement).

Concrete usually also contains a so-called filler. A filler is understood to be rock flour such as quartz powder or limestone powder which has grain sizes of less than 125 μm (DIN EN 12620).

It corresponds to the state of the art that fibers are added to the concrete for improving the tensile strength and ductility and thus the fracture and crack behavior. These fibers are embedded in the matrix. They act as reinforcement. Cracks occur in the concrete under higher tensile stresses. By using a fiber concrete, they are usually divided into numerous, very fine and thus normally harmless cracks. Glass fibers, steel fibers, natural fibers and synthetic polymer fibers are usually used (e.g.: WO 0204378 A, DE 100 30 617 A, DE 39 32 908 A, EP 1 518 840 A). Depending on the type of fiber and the application, the employed fibers have a diameter in the range of 10 to 50 μm at fiber lengths of 10 to 60 mm. Novel materials are usually used for this purpose which are relatively expensive and make concrete as a material considerably more expensive.

It corresponds to the state of the art to give further additives to the concrete in order to achieve special properties. Thermoplastic materials and/or elastomers are used for example (e.g.: WO 2002/062719 A, EP 1 026 132 A). It is further known that also respectively composed waste materials are used for this purpose in order to save the high costs for the additives.

It is further known to use waste materials as an additive for concrete. It is described in literature (G. J. Xu, D. F. Watt, P. P. Hudec, J. Mater. Process. Techn. 48, 385-390, 1995) that shredder waste is pyrolized for power generation and the residues are advantageously admixed to the concrete. The disadvantageous aspect is that exhaust gases are produced in the pyrolysis processes which require complex and expensive gas scrubbing.

Asphalt is a mixture of bitumen (bonding agent) and aggregate (fillers, sand and gravel or grit) produced at a high temperature. Asphalt can also contain additives. Asphalt is a substantially rigid building material after cooling to service temperature.

Asphalt usually further comprises a so-called filler which has a grain size of under 90 μm in a wide distribution of grain sizes (DIN 55946). The content of this filler is up to approx. 15% depending on the type of asphalt.

It is the state of the art to add various polymers to the bitumen. Especially thermoplastic materials (e.g. polyethylene, polypropylene), elastomeric materials (e.g. polybutadiene, natural rubber) and thermoelastic plastic materials (e.g. styrene-butadiene-styrene block copolymers) are used (see GESTRATA 1996 for example). The advantages of such modifiers are an improvement in the rheological and elastic properties of bitumen, an increase in viscosity at service temperature and thus an improvement of the asphalt properties such as the increase in the resistance against formation of ruts. The decisive disadvantage of polymer-modified bitumen is the high price in comparison with conventional bitumen.

It is also the state of the art to add polymers entirely or partly from waste materials to the bitumen because costs can thus be reduced drastically (e.g.: EP 0 448 425 A).

It is also the state of the art in the field of bitumen materials that fiber additives improve the product properties. It is necessary to admix stabilizing additives especially in the case of stone mastic asphalt, which is a special type of the asphalt for cover layers with a higher content of bitumen and grit with higher durability for high traffic loads such as on motorways. Usually, cellulose or synthetic fibers of between 0.3 and 1.5% of the total mass are added (e.g. EP 0 313 603 A). The addition of these fiber materials is expensive and justifies their use only for heavy-duty roads. The aggregate produced with the method in accordance with the invention is inexpensive on the other hand.

It is especially advantageous with respect to the quality of the end product when the additive has a maximum grain size of less than 750 μm, preferably less than 400 μm.

It is especially preferred when the comminution is performed up to a length-weighted mean fiber length of 10 mm, preferably 2 mm. As already explained above, the length-weighted mean fiber length is determined with the Morfi analytical system.

A further quality improvement can be achieved in such a way that the mass fraction of thermoplastic materials is set to a value of between 5% and 60%, preferably between 25% and 45%, and that the mass fraction of elastomers is set to value of between 3% and 40%, preferably between 10% and 28%.

The present invention further relates to an aggregate for the production of building materials which is substantially present in the pourable state, containing a fiber-containing waste material fraction. Said aggregate is characterized in accordance with the invention by a fiber content of between 3% and 45%, preferably between 5% and 25%, and more preferably between approx. 7% and 12%, and by a mass fraction of between 2% and 25%, preferably between 2% and 10% of a fine-grain inorganic additive.

Further aspects of the invention relate to asphalt consisting of bitumen and a rock filling and at least one aggregate of the kind mentioned above, and a concrete consisting of cement, aggregate and water and at least one aggregate of the kind mentioned above.

### BRIEF DESCRIPTION OF THE DRAWINGS

The embodiments shown the drawings are explained below in closer detail, wherein:

FIG. 1 shows a schematic diagram of the method in accordance with the invention;

FIG. 2 shows a typical probability density function of fiber diameter of the fiber fraction contained in the aggregate;

FIG. 3 shows a typical probability density function of the fiber length in the fiber fraction contained in the aggregate;

FIG. 4 shows Woehler lines for describing the fatigue behavior;

FIG. 5 shows a diagram which represents the tensile strength reserve for describing the low-temperature behavior, and

FIG. 6 shows a diagram that represents creeping impulse curves for describing the deformation behavior.

### DETAILED DESCRIPTION OF THE PREFERRED EMBODIMENTS

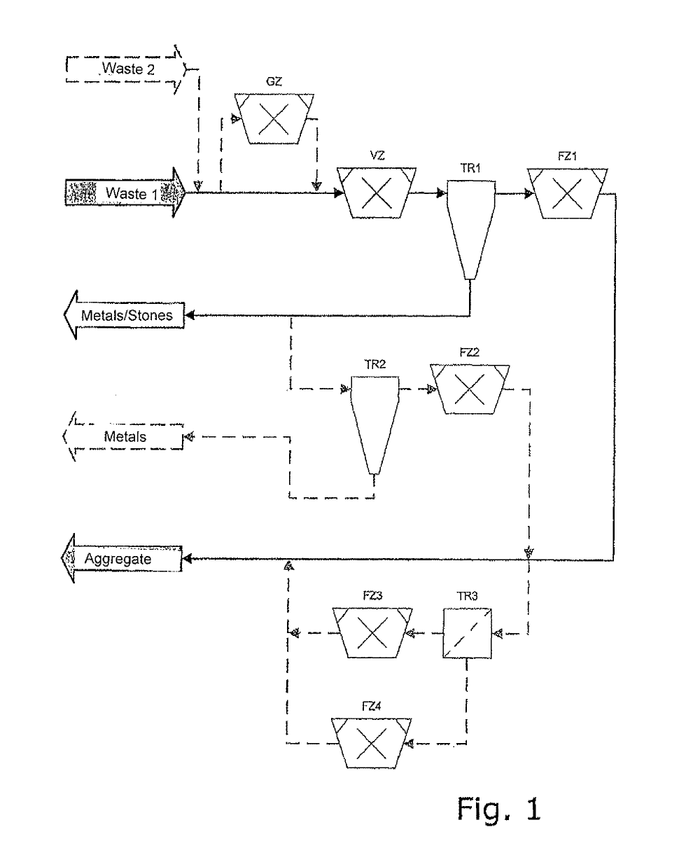

FIG. 1 shows a typical example of an arrangement of mechanical process steps for producing the aggregate in accordance with the invention. The individual process steps are explained in Table 1 in closer detail.

A single waste material (Waste 1) is used in the simplest of cases which is comminuted in a pre-comminution stage (VZ) to such an extent that metal and stones and other relatively large inorganic components can be separated in the subsequent separation (TR1). The separation of these materials now enables the subsequent fine comminution (FZ1) in order to produce the aggregate in accordance with the invention with the required fineness. The presence of very small inorganic or metallic particles does not disturb the fine comminution. This fine comminution step can be performed in one or also in several steps.

Alternatively, it is possible to use further waste material (Waste 2) or optionally also several further waste materials. Depending on the nature of the waste materials it may be necessary to provide one or several coarse comminution steps (GZ) beforehand.

The relatively coarse metallic or inorganic fractions (e.g. stones) which are separated in separation step 1 (TR1) can be directly processed further or dumped in a landfill. A separation of metals can be achieved alternatively by a further separation step (TR2), which metals can be supplied directly to a metal recycling process. The fraction which has been deprived of metallic content and is predominantly composed of inorganic components can be comminuted by a further comminution step (FZ2) in parallel thereto and can be added to the aggregate.

It can optionally be necessary to comminute the aggregate after fine comminution (FZ1) even further than is possible with conventional machines. For this purpose, the aggregate is separated via a separation device (TR3) into a fiber fraction and a non-fiber fraction. Subsequently, each fraction can be further comminuted itself by means of further comminution units (FZ3 and FZ4) which are adjusted to the respective fractions. The aggregate is then obtained by joining both fractions from FZ3 and FZ4.

TABLE 1
Examples of the concatenation of mechanical process
steps for the production of the aggregate in accordance
with the invention (see diagram in FIG. 1).

| | | Advantageous | |
|---|---|---|---|
| Abbr. | Process | machine | Note |
| GZ | Coarse | Toothed-wheel | |
| | comminution | crusher | |
| | | Universal | |
| | | shredder | |
| VZ | Preliminary | Rotary shear | Possibly also in several |
| | comminution | Cutting mill (slow) | steps |
| TR1 | Separation 1 | Wind sifter | Separation of metals and |
| | | Zigzag sifter | inorganic components |
| | | Jigger | (e.g. stones) |
| | | Air separation | |
| | | device | |
| FZ1 | Fine comminution | Cutting mill | |
| | 1 | Multi-knife mill | |
| TR2 | Separation 2 | Deflecting wheel | Separation of metals |
| | | sifters | (valuable material) and |
| | | | inorganic components |
| | | | (return process) |
| FZ2 | Fine comminution | Hammer mill | Fine comminution of the |
| | 2 | Counter-jet mill | inorganic components |
| | | | (e.g. < 125 μm) |
| TR3 | Separation 3 | Vibration screen | Separation of fibers and |
| | | Air-jet screen | non-fibers |
| FZ3 | Fine comminution | Hammer mill | Fine grinding of |
| | 3 | Counter-jet mill | non-fibers |
| FZ4 | Fine comminution | Fine-cutting mill | Fine cutting of |
| | 4 | | the fibers |

The setting of the values as demanded above for the fiber content and the mass fraction of the aggregate occurs on the one hand by a suitable mixing ratio between waste 1 and waste 2 and optionally further waste which needs to differ sufficiently in respect of their composition, and on the other hand by the setting of the separation stages TR1, TR2 and TR3. Moreover, the composition can be influenced in the desired way by the purposeful addition of fine stones and the like.

The processing in accordance with the invention also has the object of achieving favourable pourability, favourable dosing capability and/or low inclination towards the formation of agglomerates. As a result of a respective shortening, interlocking agglomerations by fibrous components are substantially prevented. It is necessary in this process to disintegrate any existing residues of fabrics and yarns nearly completely. The fibers present in the waste material are shortened to a fiber length which is typical for the field of flocks. Advantageously, the mean length-weighted fiber length is in the range of 0.3 to 2.5 mm. This ensures sufficient pourability and dosing capability, thus achieving a technically simple further processing of the aggregate. Even shorter fiber lengths improve pourability even further, but do not show any sufficient reinforcing effect in the use of the building materials according to the invention.

In order to ensure advantageous use, inorganic materials may optionally be added to the waste. Fine stones with grain sizes of under 750 μm, advantageously under 400 μm, more advantageously under 125 μm, can be added. It is provided in accordance with the invention that also inorganic waste in the suitable grain size range can be used. The mass content of the inorganic components must lie in the range of 2% to 25%.

The percentage of thermoplastic materials or elastomers might have to be corrected optionally by the addition of thermoplastic materials or elastomers. The mass fraction of the thermoplastic materials lies between 5% and 60%, that of the elastomers between 3% and 40%. Thermoplastic materials and elastomers are advantageously used from other recycling processes.

It is especially advantageous to use such waste that is already composed in such a way that a pourable product can be produced by mechanical processing without any further additives, which product meets the required specifications concerning the ratio of fibers and non-fibers, the content of inorganic and thermoplastic components and the content of elastomers. In accordance with the invention, various types of waste can be mixed in before, during or after processing in order to achieve the composition of the aggregate according to the invention.

A further advantage of the processing in accordance with the invention is that a fraction is obtained which, until the predetermined further use, can be stored, transported and further processed at a point in time that can be chosen freely.

The waste processed in accordance with the invention can now be processed advantageously for producing shaped covers such as concrete, asphalt or prefabricated products such as webs, plates or shingles. The aggregate is added as an additive and can replace other additives which correspond to the state of the art.

### EMBODIMENT

300 kg of a light shredded fraction which was already pre-sorted according to the state of the art and which is a so-called lint fraction was processed in several steps by means of mechanical processes in order to produce an aggregate in accordance with the invention. A preliminary comminution was performed in a first step. The inhomogeneous starting material was thus standardized considerably with respect to grain size. In addition, it was possible to dissolve agglomerates. This step was performed with a slowly running cutting mill. The respective process parameters are shown in Table 2.

In a second process step, any contained metals and inorganic components were removed by means of a sifting process. A zigzag sifter was used for this purpose as a suitable unit. The parameters during the sifting were chosen according to the state of the art in such a way that metals and inorganic components with grain sizes of over 0.5 mm were removed.

The light fraction was processed in a further comminution step by means of a cutting mill in order to obtain the aggregate in accordance with the invention. The used process parameters are shown in Table 3.

TABLE 2
Process parameters for preliminary comminution
of waste in a loose-mass cutting mill.

| Rotor diameter | 100 | mm |
|---|---|---|
| Rotor width | 26 | mm |
| Number of stator knives | 3 | pcs. |
| Number of rotor knives | 2 | pcs. |
| Distance between rotor | 0.4 | mm |
| and stator knives | | |
| Motor output of mill | 4.0 | kW |
| Rotor speed | 500 | min⁻¹ |
| Motor output of fan | 1.5 | kW |
| Air throughput | 180 | Nm³/h |
| Mesh width of screen | 3 mm, round hole | |
| Throughput | 54 | kg/h |

The thus obtained fraction can now advantageously be used as an aggregate. It was noticed that the fraction has a mass fraction of approx. 10% of fibers and the remaining share consists of fine particles. A screen analysis showed that approx. 90% of the particles had a grain size of less than 750 μm. A more detailed analysis showed that approx. 3% of inorganic content were contained and the content of thermoplastic materials was approx. 40%. Furthermore, there were approx. 25% of elastomers. The other parts were mainly other types of plastic.

TABLE 3
Process parameters for preliminary comminuting
waste in a loose-mass cutting mill.

| Rotor diameter | 260 | mm |
|---|---|---|
| Rotor width | 410 | mm |
| Number of stator knives | 6 | pcs. |
| Number of rotor knives | 6 | pcs. |
| Distance between rotor | 0.25 | mm |
| and stator knives | | |
| Motor output of mill | 15.0 | kW |
| Rotor speed | 2,500 | min⁻¹ |
| Motor output of fan | 1.5 | kW |
| Air throughput | 150 | Nm³/h |
| Mesh width of screen | 0.3 mm, round hole | |
| Throughput | 78 | kg/h |

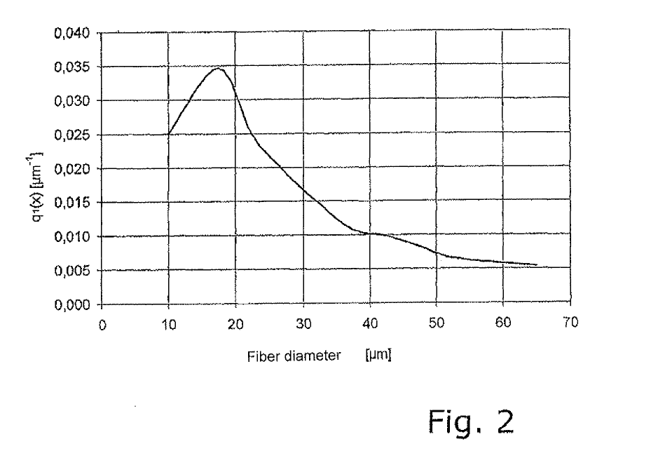

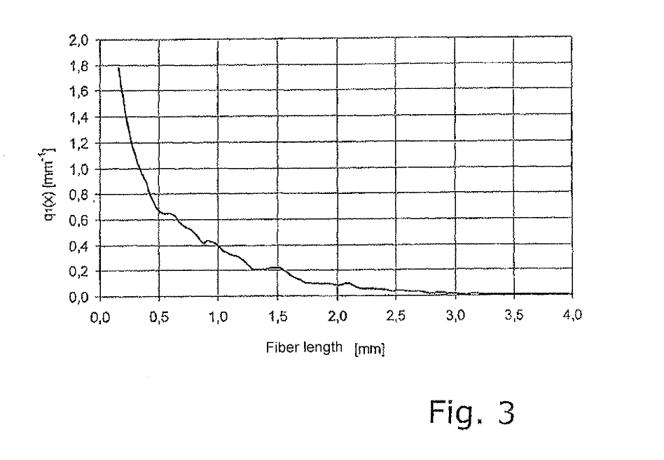

An analysis of the separated fibers showed clearly that the fibers had a diameter which was typical for chemical fibers. This shows that the processing in accordance with the invention merely shortens the fiber length without fibrillating the fibers. Table 4 shows the mean values for fiber length and fiber diameter. The respective distribution sums for fiber length and fiber diameter are shown in FIGS. 2 and 3.

TABLE 4
Statistical characteristics of the fiber fraction contained in the
aggregate in accordance with the invention (application example)
according to the examination with the Morfi analytical device.

| | Fiber length | Fiber diameter |
|---|---|---|
| Arithmetic average | 0.73 μm | 27.9 μm |
| Length-weighted length | 1.04 μm | — |
| Mean value d₅₀ | 0.50 μm | 21.2 μm |

The aggregate in accordance with the invention was subsequently used in the production of asphalt for road construction. A highly resistant stone mastic asphalt of type SMA 11 50/70 which is currently used in Austria as a cover layer material preferably in heavy-duty roads was modified with the aggregate in accordance with the invention. It was introduced into the asphalt mixing material in dry process. There was no addition of cellulose fibers (e.g. VIATOP 80+), as is necessary in conventional asphalt of this type of carrier material for bitumen.

The behavioral characteristics of an asphalt mixing material in the operating state of the road (so-called usage behavior) can be forecast in the laboratory with the help of so-called usage-behavior-oriented asphalt tests on the mixing material. The usage behavior is defined by the resistance of the asphalt against fatigue (accumulated damage by consistently high traffic loads), against cold cracking and against permanent deformation (formation of ruts).

The usage-behavior-oriented asphalt tests comprise the following types of tests: (i) Fatigue test for determining the number of permissible load changes under constant expansion until the occurrence of material fatigue as a characteristic measure for resistance to fatigue; (ii) cooling test and cold tensile strength test (low-temperature tests) for determining the tensile strength reserve as a characteristic measure for resistance against cold cracking; (iii) cyclic compressive creep test for determining the accumulated axial compression due to a dynamic semi-sinusoidal stress as a characteristic measured for deformation resistance.

The usage behavior of the asphalt modified by the aggregate in accordance with the invention was determined by the usage-behavior-oriented asphalt tests as mentioned above. The usage behavior of a conventionally produced asphalt of the same kind was determined for comparison purposes with the help of the same tests and under the same test conditions.

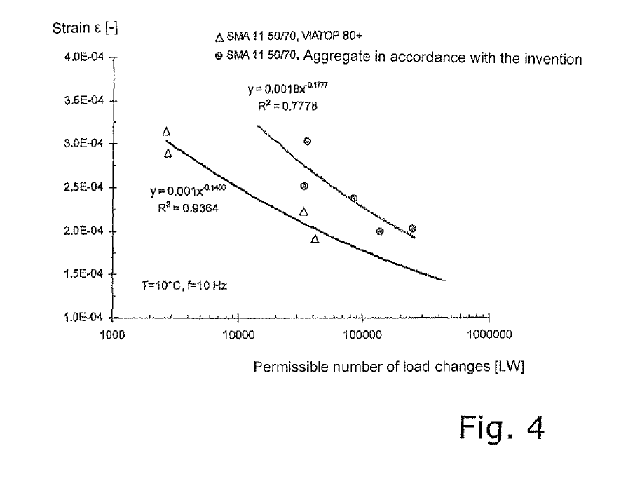

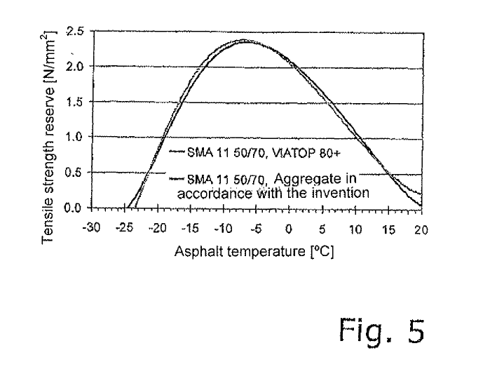

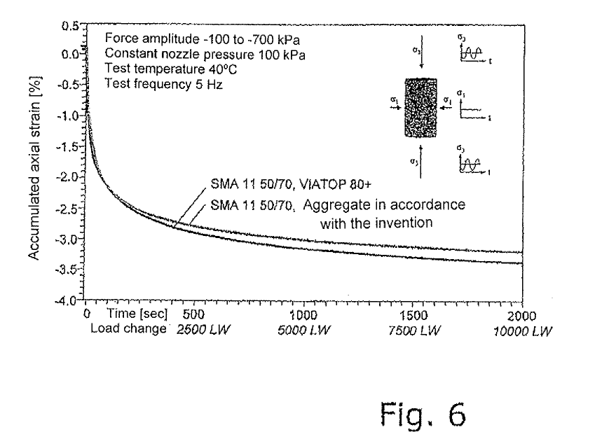

FIG. 4 shows the results of the fatigue tests for the asphalt modified with the aggregate in accordance with the invention (SMA 11 50/70, aggregate in accordance with the invention) and for conventional asphalt (SMA 11 50/70, VIATOP 80+). FIGS. 5 and 6 analogously show a comparison of the results of the low-temperature tests (FIG. 5) and the cyclic compressive creep tests (FIG. 6) for both asphalts.

The result of the usage-behavior-oriented asphalt tests can be summarized as follows. The difference in the progression of the curves of the tensile strength reserve (cf. FIG. 5) obtained for the tested asphalts and the difference in the progression of the creep impulse curves (cf. FIG. 6) each lie within the test-induced distribution of the results of the measurement. The progressions of the curves can therefore be regarded as equivalent. The fatigue curves of both asphalts differ slightly from one another (cf. FIG. 4), with the asphalt modified with the aggregate in accordance with the invention having a comparatively higher resistance to fatigue.

The expected usage behavior of the asphalt modified with the aggregate in accordance with the invention can be regarded as equivalent in comparison with conventional asphalt concerning the low-temperature and deformation behavior, and even advantageous concerning fatigue behavior.

The results of the tests thus prove an advantageous use of the aggregate in accordance with the invention as a modifying means for the tested asphalt.

is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-12. (canceled)

13. A method for producing an aggregate for the production of building materials, comprising the steps:
using a starting material containing at least one fiber-containing waste fraction that has had heavy materials removed and has been comminuted in order to obtain a substantially free-flowing aggregate, the starting material having a fiber content between 3% and 45%, and
adding a mass fraction of between 2% and 25%, of a fine-grain inorganic additive with a grain size of less than 750 μm.

14. The method according to claim 13, wherein the additive has a maximum grain size of less than 400 μm.

15. The method according to claim 13, wherein the comminution is performed up to a length-weighted mean fiber length of 10 mm.

16. The method according to claim 13, wherein the comminution is performed up to a length-weighted mean fiber length of 2 mm.

17. The method according to claim 13, wherein the aggregate contains thermoplastic materials and the mass fraction of these thermoplastic materials is set to a value of between 5% and 60%.

18. The method according to claim 13, wherein the aggregate contains elastomers and the mass fraction of these elastomers is set to a value of between 3% and 40%.

19. An aggregate for the production of building materials which has a substantially pourable form and containing a fiber-containing waste fraction, comprising:
a fiber content of between 3% and 45%, which fiber content originates mainly from a light shredded fraction, and by a mass fraction of between 2% and 25%, of a fine-grain inorganic additive with a grain size of less than 750 μm.

20. An aggregate according to claim 19, wherein the fiber-containing waste fraction comprises a fiber content of between 5% and 25%.

21. An aggregate according to claim 19, wherein the fiber-containing waste fraction comprises a fiber content of between 7% and 12%.

22. An aggregate according to claim 19, wherein the mass fraction of the fine-grain inorganic additive is between 2% and 10%.

23. An aggregate according to claim 19, wherein the mass fraction of the fine-grain inorganic additive is between 3% and 8%.

24. An aggregate according to claim 19, wherein the additive has a maximum grain size of less than 400 μm.

25. An aggregate according to claim 19, wherein the length-weighted mean fiber length is between 2 mm and 10 mm.

26. An aggregate according to claim 19, including plastic materials within the aggregate, the mass fraction of the thermoplastic materials being between 5% and 60%.

27. An aggregate according to claim 19, including plastic materials within the aggregate, the mass fraction of the thermoplastic materials being between 25% and 45%.

28. An aggregate according to claim 19, including plastic materials within the aggregate, the mass fraction of the thermoplastic materials being between 35% and 40%.

29. An aggregate according to claim 19, including elastomers within the aggregate, the mass fraction of elastomers being between 3% and 40%.

30. An aggregate according to claim 19, including elastomers within the aggregate, the mass fraction of elastomers being between 10% and 28%.

31. Asphalt, comprising bitumen and rock filling and at least one aggregate, the aggregate comprising an aggregate according to claim 19.

32. Concrete, comprising cement, crushed rock and water, and at least one aggregate, the aggregate comprising an aggregate according to claim 19.
